(19) United States
(12) Patent Application Publication
(10) Pub. No.: US 2012/0249107 A1
(43) Pub. Date: Oct. 4, 2012

(54) COUPLED INDUCTOR TO FACILITATE INTEGRATED POWER DELIVERY

(76) Inventors: Nicholas P. Cowley, Wroughton (GB); Isaac Ali, Bristol (GB); Stephen J. Spinks, Swindon (GB)

(21) Appl. No.: 13/078,333

(22) Filed: Apr. 1, 2011

(51) Int. Cl. G05F 1/00; H01F 41/06; H01F 5/02

(52) U.S. Cl. 323/290; 336/200; 29/605

(57) ABSTRACT

An embodiment of the present invention provides an apparatus, comprising a surface mounted device (SMD) inductor, the SMD inductor including at least two counter wound aircoils formed on a same SMD former; wherein the at least two counter wound aircoils are connected to three terminals on the SMD former, wherein a single terminal is connected to a common node of both windings with two independent terminals accessing the other winding node.

### BACKGROUND

The operation of the buck converter is fairly simple, with an inductor and two switches (usually a transistor and a diode) that control the inductor. It alternates between connecting the inductor to source voltage to store energy in the inductor and discharging the inductor into the load.

However, inefficiencies exist in the state of the art related to this technology and thus, a strong need exists for a new inductor component to facilitate integration of switched mode buck voltage regulators in system on chips (SOCs) to facilitate integrated power delivery.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a SMD inductor according to one embodiment of the present invention; and

FIG. 2 illustrates an integrated circuit with a power converter in accordance to an embodiment.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention combine the two discrete components in an advantageous way to deliver a desired inductance with a lower equivalent series resistance (ESR), which delivers improved efficiency and reducing the physical size of implementation. More specifically, embodiments of the present invention provide a new inductor component to facilitate integration of switched mode buck voltage regulators, which may be integrated into system-on-chips (SOC). Embodiments of the present invention address a number of performance/integration issues identified during development of power delivery technology. To name a few, benefits may include: 1) Enables a biphase buck regulator to be implemented in a similar footprint to a single phase regulator (A buck converter is a step-down DC to DC converter. Its design is similar to the step-up boost converter, and like the boost converter it is a switched-mode power supply that may use two switches (a transistor and a diode in one embodiment—and in a preferred embodiment used in the synchronous buck converter of embodiments of the present invention, the diode may be replaced by a transistor which may effectively be switched in anti phase to the first transistor), an inductor and a capacitor); 2) Reduces ESR for a given inductance so increasing regulator efficiency; and 3) Biphase implementation with this coupled component offers some improvement in line in voltage ringing and thus enables reduction in silicon area for decoupling capacitance which is typically applied to reduce such ringing.

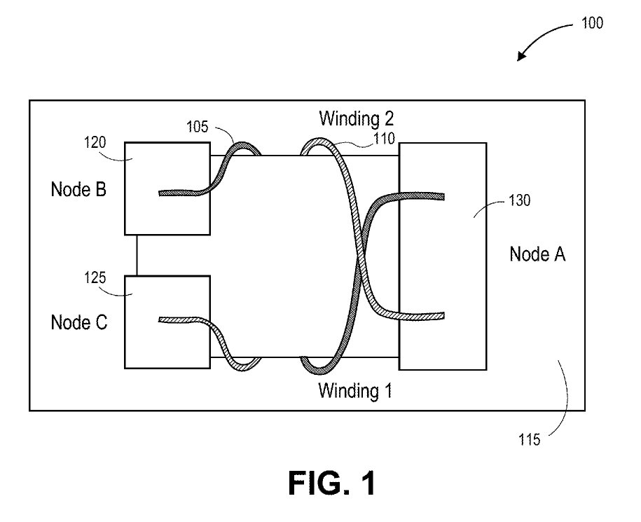

Looking now at FIG. 1, shown generally as 100, is a basic structure of embodiments of the present invention provide at least two counter wound aircoils 105 and 110 formed on the same SMD former 115. The coils are connected to three terminals 120, 125 and 130, on the SMD former 115. A single terminal is connected to a common node 130 of both windings with two independent terminals 120 and 125 accessing the other winding node. A preferred embodiment provides where node A 130 is the common node and node B 120 and C 125 are connected to other terminals of counter wound coils 105 and 110.

The principal electrical advantage in this component is the benefits afforded by mutual inductive coupling which is achieved as the windings are switched in antiphase (i.e. the signal current in winding 105 boosts the inductance in winding 2 110 and vice versa. Now for a given performance balloon there will be an optimum value of inductance. This will be determined by factors including efficiency, delivered power, voltage ripple, response time etc.

The advantage of this invention is that the physical size of the winding to deliver a given inductance will be smaller due to the benefits of mutual inductance. This in turn will lead to a reduction in equivalent series resistance (ESR), hence an improvement in efficiency and a reduction in the material content which will have a fractional cost implication. In addition there will be a physical size benefit in that since both phases of the bi-phase buck regulator are co-located, the substrate area required for component placement will be reduced, and in addition the routing from the SoC to the bi-phase inductor will occupy a narrower corridor, which is of benefit in a congested 10 routing arrangement.

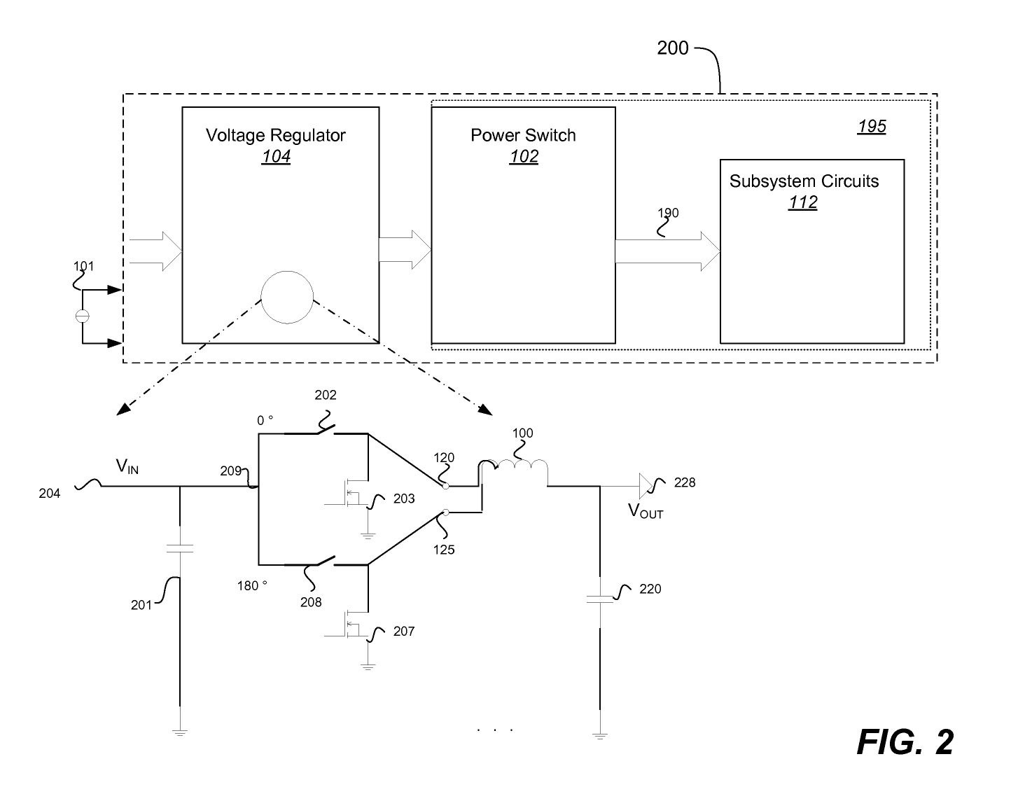

FIG. 2 illustrates an integrated circuit 200 with a power converter in accordance to an embodiment. The integrated circuit (IC) 200 includes subsystem circuits 112, power switch 102, a power converter or voltage regulator 104, and external power source 101. The integrated circuit 200 may be implemented as a system on a chip or system on chip (SoC or SOC) where the IC integrates all components of a computer or other electronic system into a single chip. In the alternative, the integrated circuit could be implemented as a system in a package where some of the elements are implemented as a SoC such as the combination 195 of power switch 102 and voltage regulator 104 and the voltage regulator could be external and coupled with the proper impedance or a bank of inductor using components like SMD inductor 100.

The power switch array 102 may have multiple pass transistors that may comprise any suitable semiconductor circuit element arranged to control a flow of power 190 passing from voltage regulators 104 to subsystem circuits 112. For example, when activated or enabled (high) pass transistors may apply power to one or more subsystem circuits 112, and when deactivated or disabled (low) may remove power to one or more subsystem circuits. Subsystem circuits 112 may comprise any subsystem circuitry using power and arranged to perform at least one function of a larger system. For example, a subsystem circuit 112 may be configured to perform at least one function of a central processing unit (CPU), system on chip (SoC), chipset circuitry and/or other IC. For example, a subsystem circuit may be configured to operate as a bus controller, floating point unit, display controller, audio controller, and so forth. Of course, these are only examples of the types of functions that may be performed by a subsystem circuit. Thus the term “subsystem circuit” as used in any embodiment herein, is intended to be construed broadly as including any subsystem of a system that is configured to perform at least one function of that system.

In the voltage regulator 104, the basic structure of a bi-phasing buck converter shown as 0° and 180°, other phase difference are possible) to which the SMD inductor 100 can be applied. The buck converter is connected to a source across capacitor 201 of DC power at a voltage VIN between an input terminal 204 and ground and supplies DC power at a voltage VOUT, smaller than VIN, to a load (not shown) connected between an output terminal 228 and ground. The basic structure of the buck converter comprises multiple switches (switch 202 and switch 208) connected in series between the input terminal 209 and a node 120 or node 125 for switch 208, the SMD inductor 100 connected in series between the node 209 and the output terminal 228, switches 203 and 207 are shown implemented using n-channel high-side and low-side MOSFETs with an electrode connected to switch 202 and switch 208 respectively and another electrode connected to ground, a control module (not shown) for controlling the ON/OFF state of the switches and hence the duty cycle of the converter and a capacitor 220 for smoothing the output voltage. Again, it will be appreciated that many variations on the basic structure shown are possible; for example the switches may be replaced by another element performing the same function. The illustrated circuit is for a bi-phase buck converter, but it should be understood that a multiphase buck converter ban be realized by adding, changing, or arranging the circuits.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a surface mounted device (SMD) inductor, said SMD inductor including at least two counter wound aircoils formed on a same SMD former and wherein said SMD inductor combines aircoil output to reduce physical size requirements for a given inductance.

2. The apparatus of claim 1, wherein said at least two counter wound aircoils are connected to three terminals on said SMD former, wherein a single terminal is connected to a common node of both windings with two independent terminals accessing the winding other nodes.

3. The apparatus of claim 2, wherein said SMD inductor is adapted to support Buck regulators in system-on-chip (SoC) technologies.

4. The apparatus of claim 3, wherein said at least two counter wound aircoils is two counter wound aircoils.

5. A method manufacturing a surface mounted device (SMD) inductor, comprising:
counter winding at least two aircoils on a same SMD former of said surface mounted device (SMD) inductor;
combining aircoil output to reduce physical size requirements for a given inductance.

6. The method of claim 5, further comprising connecting said at least two counter wound aircoils to three terminals on said SMD former, wherein a single terminal is connected to a common node of both windings with two independent terminals accessing the winding other nodes.

7. The method of claim 6, further comprising adapting said SMD inductor to support Buck regulators in system-on-chip (SoC) technologies.

8. An apparatus, comprising:
a bi-phase buck regulator; and
a surface mounted device (SMD) inductor adapted to support said bi-phase buck regulator, said SMD inductor including at least two counter wound aircoils formed on a same SMD former and wherein said SMD inductor combines aircoil output to reduce physical size requirements for a given inductance.

9. The apparatus of claim 8, wherein said at least two counter wound aircoils are connected to three terminals on said SMD former, wherein a single terminal is connected to a common node of both windings with two independent terminals accessing the winding other nodes.

10. The apparatus of claim 9, wherein said at least two counter wound aircoils is two counter wound aircoils.

11. A method of facilitating power delivery in a system on chip (SoC), comprising:
coupling a surface mounted device (SMD) inductor with said SoC, said SMD inductor including at least two counter wound aircoils formed on a same SMD former;
combining aircoil output to reduce physical size requirements for a given inductance.

12. The method of claim 11, wherein said at least two counter wound aircoils are connected to three terminals on said SMD former, wherein a single terminal is connected to a common node of both windings with two independent terminals accessing the winding other nodes.

13. The method of claim 12, wherein said SMD inductor is to support Buck regulators in system-on-chip (SoC) technologies.

14. The method of claim 13, wherein said at least two counter wound aircoils is two counter wound aircoils.
